(19) United States
(12) Patent Application Publication
(10) Pub. No.: US 2009/0245920 A1
(43) Pub. Date: Oct. 1, 2009

(54) Capless Retractable Marking Pen

(75) Inventor: Kwang Taek Jeon, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: KIMS ENTERPRISE CO., LTD., Seoul (KR)

(21) Appl. No.: 12/300,677

(22) PCT Filed: Apr. 11, 2007
(86) PCT No.: PCT/KR07/01756

§ 371 Date: Nov. 13, 2008

(30) Foreign Application Priority Data
May 18, 2006 (KR) 20-2006-0013305

(51) Int. Cl. B43K 5/16

(52) U.S. Cl. 401/109

(57) ABSTRACT

A capless retractable marking pen has excellent sealing capability and a simple structure. The capless retractable marking pen includes a hollow sealing member for receiving a writing tip when the pen is in nonuse, and an opening and closing member for opening and closing an opening provided at a front end of the sealing member. The opening and closing member has a cover part pivotably fixed at a first end thereof to a lower edge portion of a front opening of the sealing member, an extending part extended from a second end of the cover part, and fixed at a front end portion thereof to the ink cartridge, and a hole provided at the extending part so that the writing tip can be extended and retracted through the hole.

### TECHNICAL FIELD

The present invention relates to a marking pen, and more particularly, to a knock-type or capless-type marking pen, which moves a writing tip into a casing which is then sealed when the pen is not used.

### BACKGROUND ART

Generally, a marking pen refers a tool for use in writing, in which ink permeates into a tip thereof due to capillary action. Representative marking pens include highlighters, magic markers, and board markers. A marking pen must be capped so that the tip thereof does not become dry or get dirty when it is not used.

However, it often happens that a cap for a marking pen becomes lost, and besides, capping and uncapping operations for a marking pen are troublesome. Accordingly, recently, capless retractable marking pens, which are capless marking pens, are being actively researched and developed.

With reference to FIG. 1 and FIG. 2, the operation and sealing structure of the writing tip of a marking pen according to the conventional art will be described.

As shown in FIG. 1 and FIG. 2, since a spring 6 is installed in front of an ink cartridge 3 and a well-known manipulator (not shown) is provided in back of the ink cartridge 3, the writing tip 5 is toggled between a first position (See FIG. 1), which is the usage position, and a second position (See FIG. 2), which is the storage position, when a knob 2 is pushed.

As shown in FIG. 1, when the marking pen is in an unused state, the writing tip 5 is received in a sealing member 10, and an opening provided at the front end portion of the sealing member 10 is sealed by a cover 11. At this time, the spring 6 is slightly pressed, so that the string 13 becomes taut. The string 13 restricts the cover 11, thereby keeping the opening of the sealing member 10 closed.

FIG. 2 illustrates the writing tip which is in the state of being used. When the knob 2 of the marking pen, which is shown in FIG. 1, is pushed once, the ink cartridge 3 is moved forward, so that the writing tip 5 is exposed outside a casing 1. At this time, the string 13, which restricts the cover 11, is loosened and the cover 11 is pushed open by the writing tip 5 moving forward.

As shown in FIG. 2, if the knob 2 of the marking penis pushed once more, the ink cartridge 3 is moved backward by the elastic restoring force of the spring 6, and thus the writing tip 5 is received in the sealing member 10. At this time, the cover 11 of the sealing member 10 is automatically closed by the string, which becomes taut.

### DISCLOSURE OF INVENTION

### Technical Problem

However, the conventional marking pen has the following disadvantageous effects.

Since the string 13 is used to open and close the cover 11, it is difficult to assemble the marking pen. That is, when assembling the string, respective ends of the string 13 must be fixed in the fixing grooves 12a of a fixing member 12, and the middle portion of the string 13 is fixed in a fixing groove 11a provided at the front surface of the cover 11, and thus assembly work is very complicated.

When the number of uses of the marking pen is increased, the strength and/or fixed state of the string 6 are loosened, and the ability of the sealing member 10 to seal the writing tip is degraded.

Further, since the cover 11 is pushed open by the writing tip 5 when the sealing member 10 is opened, the writing tip can become dirty or dull.

### Technical Solution

Therefore, the present invention has been made in view of the above problems, and it is an object of the present invention to provide a capless retractable marking pen, which has excellent ability to seal the writing tip when the pen is in nonuse.

It is a further object of the present invention to provide a capless retractable marking pen which has a simple sealing structure and which can be easily assembled.

It is a still further object of the present invention to provide a capless retractable marking pen having a cover which is not opened by the writing tip.

In accordance with the present invention, the above and other objects can be accomplished by the provision of a capless retractable marking pen comprising a sealing member for receiving the writing tip, which is in a stored state and is disposed in a casing, and an opening and closing member for opening and closing an opening provided at a front end portion of the sealing member. The opening and closing member includes a cover part pivotably fixed at a first end thereof to an lower edge of portion of a front opening 24 of the sealing member 20, an extending part 32 extended from a second end of the cover part 31 so that the cover part opens and closes the opening as the ink cartridge moves backward and forward, and fixed at a front end portion thereof to the ink cartridge, and a hole 34 provided at the extending part 32 so that the writing tip can be come out and retracted through the hole 34.

Preferably, the hooking member is made of a flexible material, and is rigid enough in a longitudinal direction that it can open the cover part when the ink cartridge is moved forward. For this reason, when the sealing member is opened, the writing tip cannot be in contact with the inner surface of the cover part.

### Advantageous Effects

The capless retractable marking pen according to the present invention has a structure such that it can be simply sealed and easily assembled.

Further, the capless retractable marking pen according to the present invention has excellent sealing capability.

### BRIEF DESCRIPTION OF THE DRAWINGS

The above and other objects, features and other advantageous effects of the present invention will be more clearly understood from the following detailed description taken in conjunction with the accompanying drawings, in which:

FIG. 1 and FIG. 2 are cross-sectional views illustrating a marking pen according to the conventional art, in which FIG. 1 shows the tip is in nonuse(retracted mode) and FIG. 2 shows the tip is in writing mode;

FIG. 3 is an exploded perspective view illustrating a marking pen according to one embodiment of the present invention;

FIG. 4 and FIG. 5 are views illustrating a sealing member and an opening and closing member of the marking pen according to the embodiment of the present invention;

FIG. 6 and FIG. 7 are views illustrating the marking pen which is in the used state according to the embodiment of the present invention, in which FIG. 6 shows the tip is in nonuse and FIG. 7 shows the tip is in writing mode; and

FIG. 8 is a schematic view illustrating the marking pen, which is in writing mode, in greater detail.

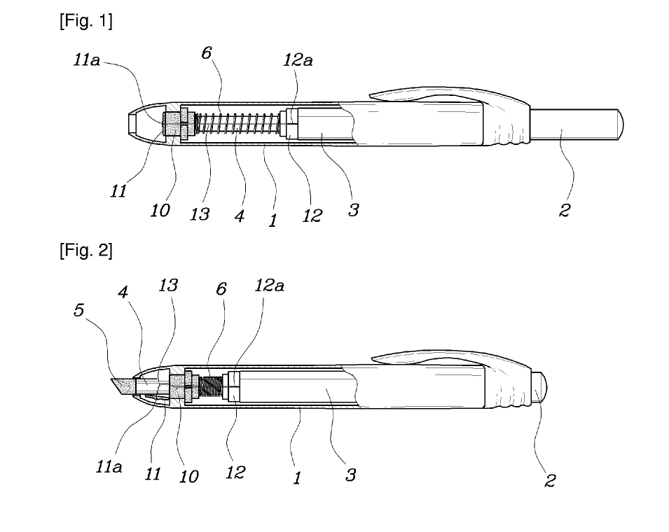

### MODE FOR THE INVENTION

Hereinafter, a capless retractable marking pen according to a preferred embodiment of the present invention will be described in more detail with reference to the accompanying drawings. Like references throughout the drawings refer to like elements in the conventional art and the present invention.

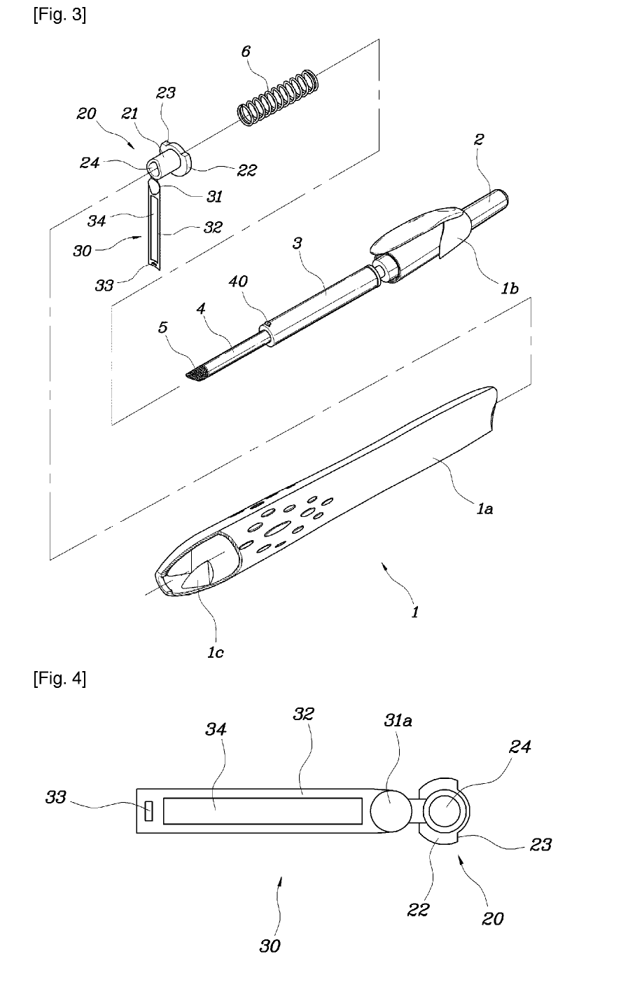

As shown in FIG. 3, a capless retractable marking pen according to one embodiment of the present invention comprises a casing 1 (1a, 1b), an ink cartridge 3 installed in the casing 1, a sealing member 20 installed in front of the ink cartridge 3, an opening and closing member 30 connected to the sealing member 20, a spring installed between the ink cartridge 3 and the sealing member 20, a manipulator (not shown) installed behind the ink cartridge 3, and a knob 2 connected to the rear end of the manipulator. A description of the operation and the spring 6 will be omitted.

The casing 1 comprises two cylindrical bodies 1a and 1b, which can be separated from each other, and the main casing 1a has two stoppers 1c on the inner surface thereof, particularly near the front end portion thereof, for hooking and fixing the sealing member 20.

The ink cartridge 3 is a storage tank for supplying ink. A connection tube 4 is connected to the front side of the ink cartridge 3 and a pen tip 5, to which ink is supplied from the ink cartridge 3, is provided to the front end portion of the connection tube 4. Further, the ink cartridge 3 has a fixing projection 40 at the front side thereof for hooking and fixing an opening and closing member 30, which will be described below.

The sealing member 20 is a member for receiving and sealing writing tip 5, and is fixedly positioned at the pen tip storage position, disposed at the front end portion of the main casing 1a. The opening and closing member 30 is provided at the front end portion of the sealing member 20 for opening and closing the opening 24 of the sealing member.

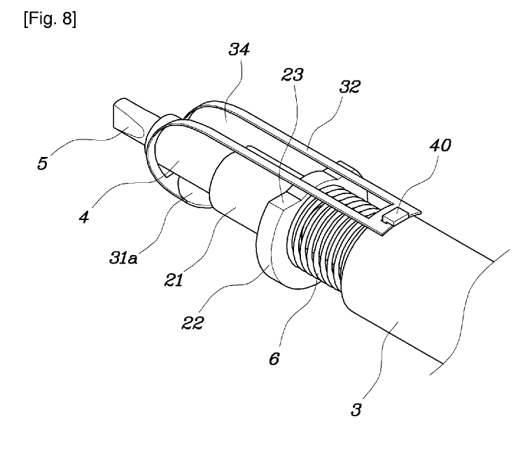

With reference to FIG. 3, FIG. 4 and FIG. 8, the sealing member 20 and the opening and closing member 30 will be described in detail.

The sealing member 20 is a hollow body and is installed at the front of the ink cartridge 3 for receiving and sealing the writing tip, which is disposed at the storage position in the casing 1. The front end of the body 21 of the sealing member 20, particularly the upper edge of the opening 24, is inclined, and the opening at the front end portion of the sealing member 20 has the oval shape. The pen tip is inserted into the sealing member 20 through an opening (not shown) provided at the rear end portion of the sealing member 20. The opening at the front end portion of the sealing member 20 is closed by the cover part 31 of the opening and closing member 30, and the opening at the rear end portion of the sealing member 20 is sealed by the connection tube 3.

The opening of the sealing member 20 is the opening 24 provided at the front end portion of the sealing member 20.

The sealing member 20 has a hooking jaw 22 at a rear end portion thereof. The hooking jaw 22 is the portion that is restricted by the stopper 1c formed on the inner surface of the front end portion of the main casing 1a, and is the portion that hooks the front end portion of the spring 6 installed in back of the sealing member 20. The opening and closing member 30, having a long hole 34 which will be described below, is received on an upper surface 23 of the hooking jaw 22.

The opening and closing member 30 has a first end connected to the lower edge portion of the opening 24, and a second end which is fixed to the ink cartridge 3 by being pushed toward the upper edge of the opening 24. The first end of the opening and closing member 30 is a cover part 31, and the second end of the opening and closing member 30 is a extending part 32.

The cover part 31 is a member for opening and closing the opening 24, and has a first end pivotably fixed to the lower edge of the opening 24. When the opening 24 is closed, the second end of the cover part 31 is in close contact with the upper edge of the opening 24. The inner surface 31a of the cover part 31 is curved to fit the shape of the opening 24 of the sealing member 20 in order to seal the opening 24 by being in close contact with the front end of the sealing member 20.

The extending part 32 is a member which is made of a flexible material, and is extended from the second end of the cover part 31. The extending part 32 has a fixing hole 33 at a front end portion thereof so that the extending part 32 can be hooked into the fixing projection 40 which is provided at a front end portion of the ink cartridge 3. The extending part 32 has a long hole 34 formed in the longitudinal direction of the extending part 32. The size and shape of the long hole 34 must be determined in consideration of flexibility and rigidity in the longitudinal direction of the extending part 32.

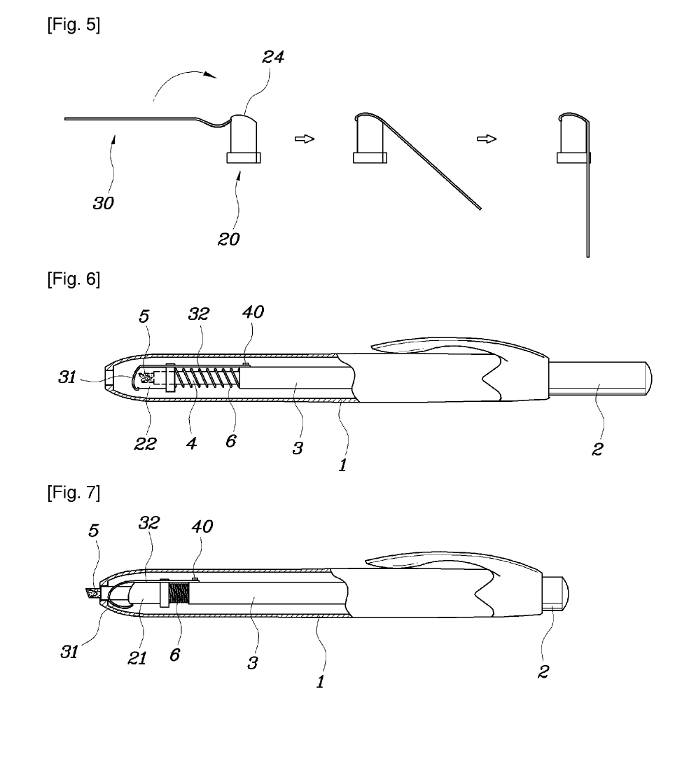

The sealing member 20 and the opening and closing member 30 having the above-described structure are integrated as a single body through a molding method so that they can be easily assembled with the marking pen. The feature disposed on the leftmost side of the drawing shown in FIG. 5 is a feature obtained right after molding the sealing member 20 and the opening and closing member 30 as a single body. When the marking pen is assembled, the extending part 32 is pivoted in the direction in which the cover part 31 seals the opening 24 (the extending part is pivoted clockwise about 270 degrees, as shown in FIG. 5), and the hooking groove 33 is hooked by the fixing projection 40.

With reference to FIG. 6 through FIG. 8, a method of using the marking pen and a method of sealing the writing tip of the marking pen will be described below.

FIG. 6 illustrates the state in which the writing tip 5 is received and stored in the casing 1. The opening 24 of the sealing member in which the writing tip 5 is received is sealed by the cover part 31. At this time, the spring 51 is lightly pressed, and the extending part 32 pulls the cover part 31 backward.

FIG. 7 illustrates the writing tip 5 which is in the usage state, in which the writing tip 5 is exposed outside the casing 1. As shown in FIG. 7, if the knob 53 shown in FIG. 6 is pushed once, the ink cartridge is moved forward, and at this time the cover part 31 is opened by the tension of the extending part 32. At this time, as shown in FIG. 8, the writing tip 5 is exposed outside, passing through the long hole 34 provided at the extending part 32, and the writing tip 5 and the extending part 32 do not interfere with each other.

If the knob 53 shown in FIG. 7 is pushed once more, the ink cartridge 50 is moved backward by the elastic restoring force of the spring 6. As a result, the writing tip 5 is received in the body 21 of the sealing member. Further, as the ink cartridge 3 is moved backward, the extending part 32 is also moved backward. As a result, the cover part 31 closes the opening 24 of the sealing member 20.

As shown in FIG. 8, the extending part 32 and the upper surface 23 of the hooking jaw 22 are separated from each other by a predetermined length. However, in the case in which the ink cartridge 3 and the body 21 of the sealing member become far away from each other, the extending part 32 is safely received on the upper surface 23 of the hooking jaw 22.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A capless retractable marking pen having a writing tip connected to an ink cartridge, comprising:
a hollow sealing member, which is installed in front of the ink cartridge and into a rear portion of which the writing tip is inserted; and
an opening and closing member including:
a cover part pivotably fixed at a first end thereof to a lower edge portion of a front opening of the sealing member, an extending part extended from a second end of the cover part, and fixed at a front end portion thereof to the ink cartridge, and
a hole provided at the extending part so that the writing tip can be extended and retracted through the hole.

2. The capless retractable marking pen according to claim 1, wherein the extending part is made of a flexible material and is sufficiently rigid in a longitudinal direction such that the cover part is forced to be opened when the ink cartridge is moved forward.

3. The capless retractable marking pen according to claim 1, wherein an upper edge of the opening, with which the second end of the cover part comes into close contact, is inclined.

4. The capless retractable marking pen according to claim 3, wherein an inner surface of the cover part is curved to fit a shape of the opening.

5. The capless retractable marking pen according to claim 1, wherein a hole of the extending part is extended in a longitudinal direction of the extending part.

6. The capless retractable marking pen according to claim 1, wherein the sealing member and the opening and closing member are integrated as a single body through a molding method.

7. The capless retractable marking according to claim 1, wherein the sealing member has a hooking jaw at a rear end thereof.
